(19) United States
(12) Patent Application Publication
(10) Pub. No.: US 2005/0108194 A1
(43) Pub. Date: May 19, 2005

(54) System for verifying a state of an environment

(75) Inventor: Andrew David Clifton, Bishop's Waltham (GB)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 10/926,586

(22) Filed: Aug. 26, 2004

(30) Foreign Application Priority Data
Nov. 18, 2003 (GB) 0326794.5

(51) Int. Cl. G06F 7/00

(52) U.S. Cl. 707/1

(57) ABSTRACT

A system for use in an environment comprising at least two resource managers, wherein each of the at least two resource managers has an associated resource. The environment also comprises a plurality of entities, wherein each of the plurality of entities requests an operation on each of the associated resources. The system comprises a comparison component, responsive to completion of the plurality of entities, for comparing a corresponding aspect (e.g. content of the resources, responses sent by the resource managers) of each of the at least two resource managers; a matching component, responsive to the comparison means, for determining whether the corresponding aspects match; and a verification component, responsive to a successful determination, for verifying a state of the environment. The at least two resource managers are disparate products.

### FIELD OF THE INVENTION

The present invention relates to a system for verifying a state of an environment.

### BACKGROUND OF THE INVENTION

In an environment wherein multiple entities (e.g. applications, processes, services etc.) request operations (e.g. read, delete) on a resource (an item that is available to the entity) associated with a resource manager (which provides access to the resource), a system for verifying the state of the environment is typically provided. The system aids determination of whether or not there is a problem associated with one or more of: the entities, the operations, the resource, the resource manager etc., after completion of the entities.

An example of such an environment (100) will now be described with reference to FIG. 1, wherein the environment (100) supports multiple applications (105, 110). The environment (100) comprises a resource manager (115) having an associated resource (120) (in this case, a file).

Firstly, Application 1 (105) requests an operation to delete the entire file by sending the operation to the file via the resource manager (115). After it has sent the operation, Application 1 (105) sends a status communication to Application 2 (110). The status communication provides the other entities in the environment (in this case, Application 2 (110)) with information regarding the operation that has been requested and therefore the way in which the entity that has generated the status communication (in this case, Application 1 (105)) should have affected the environment (in this case, the information informs Application 2 (110) that a delete operation on the entire file has been requested). The status communication can be sent either before or after an operation is requested and is sent by each entity to all other entities in the environment (in this case, Application 2 (110) also sends a status communication to Application 1 (105) after it requests an operation on the file.)

Once Application 2 (110) receives the status communication, a prediction mechanism uses the information to predict the state of the environment. This prediction can involve predicting the way in which an operation (in this case, the operation sent by Application 1 (105)) should have completed, predicting the state of the resource after operations have completed, predicting the way in which the resource manager should handle an operation etc.

For example, if Application 2 (110) now sends a copy operation in order to copy the entire file, the prediction mechanism uses the information in the status communication to predict that the copy operation should fail because the file should not exist at all.

Once all entities have completed, a verification component uses the prediction of the state of the environment as a check against the actual state of the environment, in order to verify the actual state. If there is a discrepancy, a problem in the environment has occurred and further problem analysis can be executed in order to determine more details about the problem (e.g. the cause of the problem etc.).

Although the system described above aids problem determination, there are associated disadvantages. For example, the status communication mechanism contributes to a performance overhead in the environment, in that if there are a large number of entities, several associated status communications need to be sent. Also, extra information (e.g. results from an operation) can be included in each status communication, which will result in significant amounts of data being transferred. Furthermore, when there are a large number of entities involved, the prediction mechanism becomes complex.

Thus there is a need for an improved system that allows the state of an environment to be verified.

### SUMMARY OF THE INVENTION

Accordingly, the present invention provides a system for use in an environment comprising at least two resource managers, wherein each of the at least two resource managers has an associated resource; a plurality of entities, wherein each of the plurality of entities requests an operation on each of the associated resources, the system comprising: a comparison component, responsive to completion of the plurality of entities, for comparing a corresponding aspect of each of the at least two resource managers; a matching component, responsive to the comparison means, for determining whether the corresponding aspects match; and a verification component, responsive to a successful determination, for verifying a state of the environment; wherein the at least two resource managers are disparate products.

Preferably, the matching component determines whether the corresponding aspects are equivalent. Preferably, the system further comprises a first error response generating component, responsive to an unsuccessful determination, for generating an error response.

In one embodiment, the corresponding aspects are the contents of the resources. In another embodiment, the corresponding aspects are responses sent by the at least two resource managers in response to receiving an operation request. In the latter embodiment, preferably, prior to operating the comparison component, the system further comprises a response-checking component for checking whether the responses have been sent. Preferably, if the check is unsuccessful, the system further comprises a second error response generating component for generating an error response.

In one embodiment, the comparison component further comprises a parsing component and a further matching component. In another embodiment, the comparison component further comprises a parsing component, a lookup component and a further matching component.

Advantageously, by providing resource managers that are disparate products, the present invention increases the reliability of the verification of the state of the environment. Advantageously, the present invention supports an environment in which multiple entities can manipulate a resource and wherein a state of the environment can be verified without the status communication mechanism, which is complex and an overhead.

### BRIEF DESCRIPTION OF THE DRAWINGS

The present invention will now be described, by way of example only, with reference to preferred embodiments thereof, as illustrated in the following drawings:

FIG. 1 is an overview diagram of a prior art system, wherein multiple entities manipulate a resource;

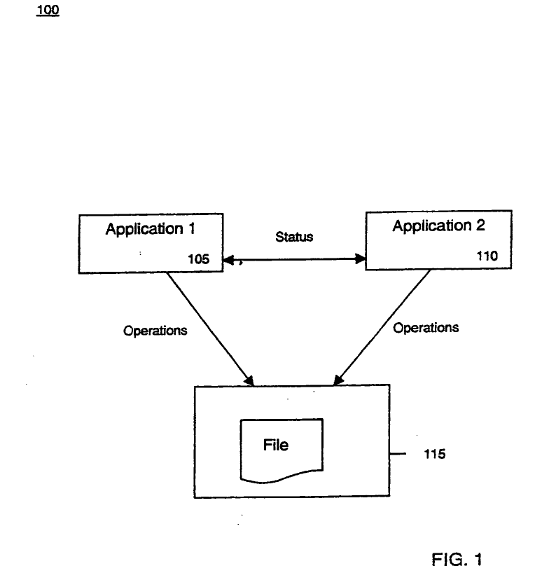

FIG. 2 is an overview diagram of an environment that allows multiple entities to manipulate a resource on at least two disparate resource managers, in accordance with the present invention;

FIG. 3 is a flow chart showing the operational steps involved in a process that allows verification of the environment of FIG. 2; and

FIG. 4 is a flowchart showing the operational steps involved in one embodiment of the method of FIG. 3.

### DETAILED DESCRIPTION OF THE PREFERRED EMBODIMENT

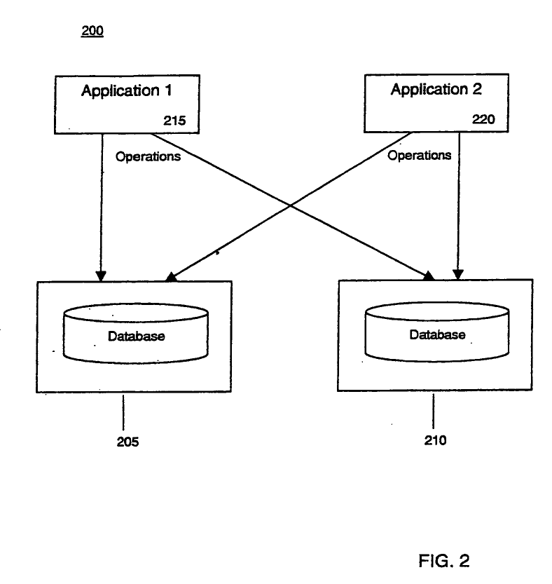

With reference to FIG. 2, there is shown an environment (200) comprising at least two resource managers—in this example, there are two resource managers (205, 210). The two resource managers (205, 210) are disparate products. For example, one resource manager is an Oracle (Oracle is a registered trademark of Oracle Corporation) product and the other resource manager is an IBM (IBM is a registered trademark of International Business Machines Corporation) product. For example purposes only, there are two sub-environments—a first sub-environment comprising multiple entities requesting operations on one of the two resource managers and a second sub-environment comprising multiple entities requesting operations on the other of the two resource managers.

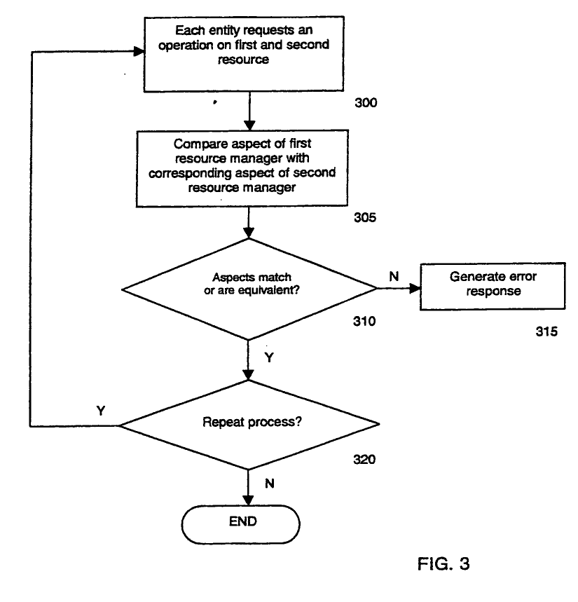

The present invention will now be described with reference to FIGS. 2 and 3. Each of the two resource managers comprises a resource, wherein the resources in the two resource managers are identical. In this example, the resource is a database. The system (200) also comprises a plurality of entities (Application 1 (215) and Application 2 (220)). Each entity requests one or more operations on the resources by sending (step 300) the one or more operations to the resources, wherein each operation is sent twice, that is, via the first resource manager (205) (i.e. once) and via the second resource manger (210) (i.e. twice).

Once all of the entities have completed, a comparison component compares (step 305) an aspect of one resource manager with the corresponding aspect of the other resource manager. The results are provided to a matching component and then a verification component, which uses them to verify the states of the sub-environments.

Since the resources were initially identical, the entities should have the same effects on the resources and the states of the sub-environments following completion of the entities should be the same.

Therefore, if the matching component finds that the aspects do not match (whereby the term match also covers “fuzzy matching” or equivalence) or are not equivalent (negative result to step 310) the results from the comparison component are sent to the verification component and it determines that the states of the sub-environments after the entities have completed are not the same. Therefore, there is a problem with at least one of the sub-environments (i.e. there may be a problem with one or other or both of the sub-environments). For example, there may be a problem with the one or more of: the entities; the operations; the resource managers; the resources etc. optionally, an error response generating component generates an error response (step 315).

Now, optionally, a problem analysis process can be executed in order to determine the cause of the problem etc. Therefore, it can be seen that the present invention can work with existing techniques that carry out problem analysis. Alternatively, information from the process thus far can be “dumped” to a file or printed out in a report to aid future problem analysis.

The process now passes to step 320, where a determination is made as to whether or not the process is to repeat. In response to a positive result to step 320, the process passes to step 300, wherein more operations are sent and the process is repeated. In response to a negative result to step 320, the process ends.

If the matching component finds that the aspects match or are equivalent (positive result to step 310), the results from the comparison component are sent to the verification component, which determines that the states of the sub-environments after the entities have completed are the same. The states of the sub-environments, following requests for an operation have therefore been verified. Next, the process passes to step 320 (as described above).

An example will now be described, with reference to FIG. 3, wherein the aspects of the resource managers to be compared are the content of the databases. In this example, an initial value of a 4^{th} entry of the databases is 5. Firstly, Application 1 (215) requests (step 300) an operation (e.g. a multiply operation—“multiply the 4^{th} entry by two”) on the database held by the first resource manager (205) and on the database held by the second resource manager (210). Application 2 (220) also requests (step 300) an operation (e.g. a subtract operation—“subtract four from the 4^{th} entry”) on the database held by the first resource manager (205) and on the database held by the second resource manager (210).

After the applications have completed, the process now passes to step 305, wherein the contents of the databases (i.e. the 4^{th} entry in the databases) are compared by the comparison component. In a first example, the value of the 4^{th} entry in the database held by the first resource manager (205) is 6 and the value of the 4^{th} entry in the database held by the second resource manager (210) is 7. Since the databases in the two disparate resource managers (205, 210) were initially identical, the entities should have had the same effects on each database (i.e. the entries should match, after the entities have completed). The matching component determines that the entries do not match (negative result to step 310) and therefore the verification component determines that the states of the databases are not the same (and therefore the states of the sub-environments are not the same). Optionally, an error response generating component generates an error response (step 315) to indicate that there is a problem associated with at least one sub-environment. Further or future analysis can then be carried out. The process now passes to step 320 (as described above).

In a second example, when the comparison component is executed (step 305), the results are that the value of the 4^{th} entry in the database held by the first resource manager (205) is 6 and the value of the 4^{th} entry in the database held by the second resource manager (210) is 6. In this case, the matching component determines that the entries in the databases match (positive result to step 310) and when these results are sent to the verification component, it determines that the states of the databases are the same (and therefore the states of the sub-environments are the same). The states of the sub-environments, following requests for an operation have therefore been verified and the process now passes to step 320 (as described above).

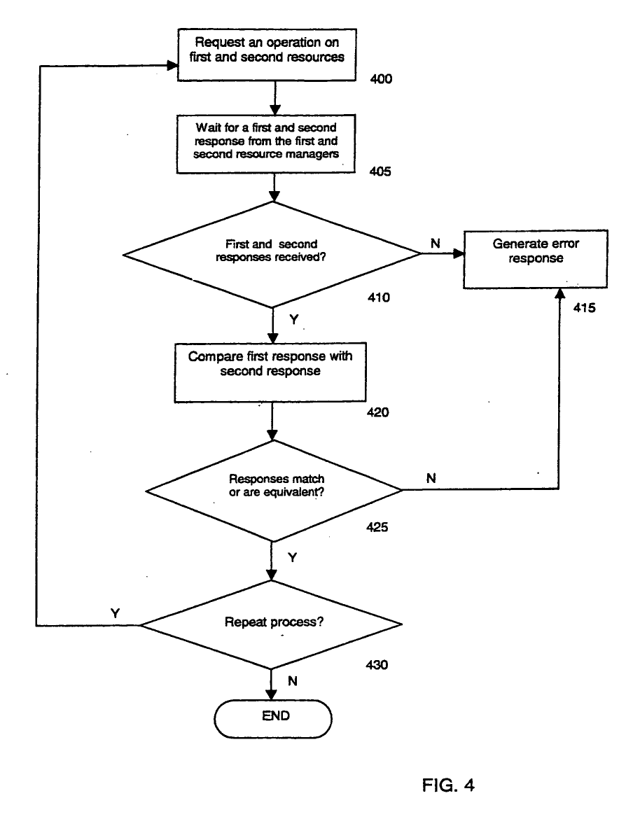

Another example will now be described, with reference to FIG. 4 (and with reference to FIG. 2), wherein the aspects to be compared are responses sent by the resource managers. It is assumed that once an entity requests an operation on the resources, a response is sent by each of the resource managers. Firstly, Application 1 (215) requests (step 400) an operation (in this case, a move operation—“move the 10^{th} row up by two places”) on the database held by the first resource manager (205) and on the database held by the second resource manager (210). Application 2 (220) also requests (step 400) an operation (in this case, a delete operation—“delete the 8^{th} entry”) on each of the databases.

Next, the process waits (step 405) for responses from each resource manager (205, 210) to each of the requested operations. For each requested operation, a response checking component determines whether or not responses have been sent by the resource managers (205, 210). If one of the responses has not been sent (negative result to step 410) an error response generating component generates an error response (step 415). For each requested operation, if both of the responses have been sent (positive result to step 410), the process now passes to step 420 wherein for each operation, the responses sent from the resource managers (205, 210) are compared by the comparison component. In one embodiment, the comparison component comprises a parsing component that parses each response and a further matching component that determines whether the outputs from the parsing component match.

It should be understood that the comparison component can work in other ways. For example, the responses sent by the two disparate resource managers may not be identical but are equivalent and therefore solely a further matching component is not appropriate. One example of a more appropriate comparison component comprises a parsing component, a lookup component and a further matching component, wherein equivalent responses from the resource managers are associated with each other in a data structure. When a first response is sent by one resource manager, it is parsed by the parsing component and the lookup component looks up the first response in the data structure to find the associated equivalent response. Therefore, when a second response is sent by another resource manager, the further matching component determines whether the second response matches the equivalent response found by the lookup component.

In a first example, for the first operation, when the comparison component is executed (step 420), the results are that the first response is “10^{th} entry has been moved” and the second response is “10^{th} entry has not been moved”. For the second operation, the first response is “8^{th} entry has been deleted” and the second response is “8^{th} entry has been deleted”. The matching component finds that the responses from the first operation do not match (negative result to step 425) and when these results are sent to the verification component, it determines that the states of the resource managers are not the same (and therefore the states of the sub-environments are not the same).

Optionally, an error response generating component generates an error response (step 415) to indicate that there is a problem associated with at least one sub-environment and the process now passes to step 430 where a determination is made as to whether or not the process is to repeat. In response to a positive result to step 430, the process passes to step 400. In response to a negative result to step 430, the process ends.

In a second example, for the first operation, when the comparison component is executed (step 420), the results are that the first response is “10^{th} entry has been moved” and the second response is “10^{th} entry has been moved”. For the second operation, the first response is “8^{th} entry has been deleted” and the second response is “8^{th} entry has been deleted”. The matching component finds that all of the responses match (positive result to step 425) and when these results are sent to the verification component, it determines that the states of the resource managers are the same (and therefore the states of the sub-environments are the same). The states of the sub-environments, following requests for an operation have therefore been verified and the process now passes to step 430 (as described above).

Advantageously, this embodiment provides a “coarse grained” mechanism that provides an initial alert when the aspects associated with the resource managers do not match or are not equivalent. Therefore, analysis of the resources themselves, which may increase the amount of processing required, can be left until a later point.

The present invention utilizes at least two disparate resource managers, which increases the reliability of the verification. If at least two copies of the same resource manager are utilized, the chance of errors in the results from verification is increased because the copies of the same resource manager will comprise the same defects, bugs etc.

In one example, for an operation, if it is determined that the responses sent by two or more identical resource managers match, this may be because of a certain error that is present in both copies of the resource manager. For instance, the resource managers may always send a response of “data not found” when a particular entry is manipulated, even when the entry comprises data. Therefore, when an update operation is sent to a spreadsheet on each of the two or more identical resource managers and when the responses received are compared, they will match. This will indicate that the states of the spreadsheets (and sub-environments) are the same.

A situation may arise wherein the operations have not completed in the same way, meaning that the states of the spreadsheets (and sub-environments) are not the same. However, the responses received (i.e. “data not found”) will match, indicating that the states are the same and that the states have been verified. This is an erroneous result. Detecting this situation will not be easy, as some knowledge of the resource managers (and the particular defects, bugs etc.) is required. However, this disadvantage is less likely to occur when utilizing at least two resource managers of different kinds, because there is a lesser chance that they will comprise the same defects, bugs etc.

It should be understood that the robustness of the verification increases as the number of disparate resource managers utilised increase. In an example wherein twenty resource managers are utilised, if corresponding aspects of the resource managers are compared and if a large proportion (e.g. 18 out of 20) of the results match or are equivalent, this indicates that a problem lies with the resource managers that have associated failed comparison results. This mechanism therefore allows the possible source of the problem in the environment to be identified more easily.

It is desirable that operations from multiple entities are requested on resources in the same order. In a first example, a value held in the databases on the resource managers (205, 210) is “3”. Firstly, Application 1 (215) updates the value of the resource associated with the first resource manager (205) to “4” and receives a response of “value updated to 4”. Next, Application 2 (220) reads the value of the resource associated with the second resource manager (210) and receives a response of “value is 3”. Next, Application 1 (215) updates the value of the resource associated with the second resource manager (210) to “4” and receives a response of “value updated to 4”. Next, Application 2 (220) reads the value of the resource associated with the first resource manager (205) and receives a response of “value is 4”.

For each operation, when the responses that have been sent are compared, it is found that the responses to the operations sent to Application 1 (215) match and the responses to the operations sent by Application 2 (220) do not match. Although this indicates that the state of at least one of the databases is incorrect (and therefore the state of at least one sub-environment is incorrect), the reason for the failure is the order in which the operations were requested.

Therefore, a mechanism to prevent false errors from occurring is required. One such mechanism is now described, wherein each entity accesses resources in order. For example, in an environment comprising two resources, each resource is locked until Application 1 (215) has completed requesting an operation on the resources. After Application 1 (215) has completed, only then can Application 2 (220) access the resources. This will then prevent Application 2 (220) from reading a resource out of sequence, because Application 1 will be sending an operation to it and therefore the (first and) second resource will be locked. This mechanism is typically implemented as part of a resource manager.

The present invention is preferably embodied as a computer program product for use with a computer system. Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

1. A system for use in an environment comprising at least two resource managers, wherein each of the at least two resource managers has an associated resource; a plurality of entities, wherein each of the plurality of entities requests an operation on each of the associated resources, the system comprising:
a comparison component, responsive to completion of the plurality of entities, for comparing a corresponding aspect of each of the at least two resource managers;
a matching component, responsive to the comparison means, for determining whether the corresponding aspects match; and
a verification component, responsive to a successful determination, for verifying a state of the environment;
wherein the at least two resource managers are disparate products.

2. A system as claimed in claim 1, wherein the corresponding aspects are the contents of the resources.

3. A system as claimed in claim 1, wherein the corresponding aspects are responses sent by the at least two resource managers in response to receiving an operation request.

4. A system as claimed in claim 3, wherein prior to operating the comparison component, the system further comprises a response-checking component for checking whether the responses have been sent.

5. A system as claimed in claim 1, further comprising a first error response generating component, responsive to an unsuccessful determination, for generating an error response.

6. A system as claimed in claim 4, further comprising a second error response generating component, responsive to an unsuccessful check, for generating an error response.

7. A system as claimed in claim 1, wherein the comparison component further comprises a parsing component and a further matching component.

8. A system as claimed in claim 1, wherein the comparison component further comprises a parsing component, a lookup component and a further matching component.

9. A system as claimed in claim 1, wherein the matching component determines whether the corresponding aspects are equivalent.
